(19) United States
(12) Patent Application Publication
(10) Pub. No.: US 2019/0045532 A1
(43) Pub. Date: Feb. 7, 2019

(54) METHOD AND TERMINAL FOR DETECTING SCHEDULING INSTRUCTIONS

(71) Applicant: YULONG COMPUTER TELECOMMUNICATION SCIENTIFIC (SHEN ZHEN) CO., LTD., Shenzhen (CN)

(72) Inventors: YA-JUN ZHU, Shenzhen (CN); MING-JU LI, Shenzhen (CN); YUN-FEI ZHANG, Shenzhen (CN)

(73) Assignee: YULONG COMPUTER TELECOMMUNICATION SCIENTIFIC (SHENZHEN) CO., LTD., Shenzhen (CN)

(21) Appl. No.: 16/075,666

(22) PCT Filed: Sep. 29, 2016
(86) PCT No.: PCT/CN2016/100775

§ 371 Date: Aug. 6, 2018

(30) Foreign Application Priority Data
Feb. 5, 2016 (CN) 201610082594.4

(51) Int. Cl. H04W 72/12; H04W 72/04

(52) U.S. Cl. CPC H04W 72/1289; H04W 88/023; H04W 72/0446; H04W 72/042

(57) ABSTRACT

The embodiments of the present disclosure provide a method for detecting scheduling instructions. The method includes: a terminal detecting Downlink Control Information (DCI) used for a multi-subframe or cross-subframe data transmission in each subframe; or the terminal detecting the DCI used for the multi-subframe or cross-subframe data transmission in a subframe notified by a base station; or the terminal determining a subframe in which a trigger instruction is to take effect upon receiving the trigger instruction from the base station; and the terminal detecting the DCI used for the multi-subframe or cross-subframe data transmission, starting with a subframe in which the trigger instruction is to take effect. The embodiments of the present disclosure further provide a terminal. By implementing the present disclosure, the terminal can accurately determine and detect scheduling instructions, so as to implement multi-subframe or cross-subframe scheduling.

### CROSS-REFERENCE TO RELATED APPLICATIONS

The present disclosure claims a priority of a Chinese patent application, which is filed in Chinese Patent Office on Feb. 5, 2016, named “method and terminal for detecting scheduling instructions,” and numbered 201610082594.4. All contents of Chinese patent application are hereby incorporated by reference in the present application.

### FIELD

The present disclosure relates to communication technology, in particular to a method and a terminal for detecting scheduling instructions.

### BACKGROUND

With the rapid development of mobile services, capacity of existing wireless frequency spectrums allocated to mobile services has been unable to meet requirements. In the 3rd Generation Partnership Project (3GPP) Rel-13 phase, a mechanism called Licensed Assisted Access (LAA) has been introduced. In the LAA mechanism, transmissions of mobile communication can be carried out on unlicensed frequency spectrums, such as 5 GHz frequency bands. These unlicensed frequency spectrums are currently mainly used by Wi-Fi, BLUETOOTH™, radar, medical, and other systems.

Due to diversity and complexity of systems on the unlicensed frequency spectrums, direct use of the Long Term Evolution (LTE) mechanism on the unlicensed frequency spectrums does not guarantee user security and connection stability. Therefore, in the LAA mechanism, licensed frequency spectrums are used to assist access on the unlicensed frequency spectrums through a Collision Avoidance (CA) mechanism. Currently, if LTE is used on the unlicensed frequency spectrums, the systems can have two working modes.

In LAA systems, in order to ensure fair sharing of the unlicensed frequency spectrums with other systems, a listen before talk (LBT) mechanism is introduced. That is, before transmitting data, a sender is required to detect whether a channel is idle. Data can be sent only when the channel is idle. The usage of the LBT mechanism may interrupt a data transmission to a base station or a terminal.

In the design of the LAA, considering the limitation of the maximum transmission time after occupying the channel, it is necessary to reduce the transmission cost of control signaling as much as possible. In addition, the transmission of uplink data is limited by the maximum transmission time and the traditional scheduling, which may result in scheduling instructions not being found. Therefore, a concept of a multi-subframe scheduling or a cross-subframe scheduling is proposed at present. However, how to perform a cross-subframe or multi-subframe scheduling is a hot research topic.

### SUMMARY

The technical problem to be solved by the embodiments of the present disclosure is to provide a method and a terminal for detecting scheduling instructions. The terminal can find scheduling instructions in subframes, to implement a multi-subframe or cross-subframe scheduling.

In order to solve the above-mentioned technical problem, a method for detecting scheduling instructions is provided in an embodiment of the present disclosure, the method including:

a terminal detecting Downlink Control Information (DCI) used for a multi-subframe or cross-subframe data transmission in each subframe; or

the terminal detecting the DCI used for the multi-subframe or cross-subframe data transmission in a subframe notified by a base station; or

the terminal determining a subframe in which a trigger instruction is to take effect upon receiving the trigger instruction from the base station; and

the terminal detecting the DCI used for the multi-subframe or cross-subframe data transmission, starting with a subframe in which a multi-subframe or cross-subframe operation is to be triggered to take effect.

Correspondingly, a terminal is further provided in an embodiment of the present disclosure, including:

a first detection module configured to detect DCI used for a multi-subframe or cross-subframe data transmission in each subframe; or

a second detection module configured to detect the DCI used for the multi-subframe or cross-subframe data transmission in a subframe notified by a base station; or

a determination module configured to determine a subframe in which a trigger instruction is to take effect upon receiving the trigger instruction from the base station;

a third detection module configured to detect the DCI used for the multi-subframe or cross-subframe data transmission, starting with a subframe in which a multi-subframe or cross-subframe operation is to be triggered to take effect.

Implementation of the embodiments of the present disclosure will have the following advantages:

the terminal detects the DCI used for the multi-subframe or cross-subframe data transmission in each downlink subframe, or a downlink subframe notified by the base station, or a subframe in which the trigger instruction of the base station is located. Therefore, the terminal can accurately determine and detect scheduling instructions, so as to implement the multi-subframe or cross-subframe scheduling.

### BRIEF DESCRIPTION OF THE DRAWINGS

In order to describe the technical solutions in embodiments of the present disclosure or in the prior art more clearly, the following briefly introduces the accompanying drawings needed for describing the embodiments. Obviously, the accompanying drawings in the following description show some embodiments of the present disclosure, and persons of ordinary skill in the art may still derive other drawings from these accompanying drawings without creative effort.

FIG. 1 is a flow chart of a method for detecting scheduling instructions, in one embodiment of the present disclosure;

FIG. 2 is another flow chart of a method for detecting scheduling instructions in one embodiment of the present disclosure;

FIG. 3 is a schematic structural diagram of a terminal provided in one embodiment of the present disclosure;

FIG. 4 is another schematic structural diagram of a terminal provided in one embodiment of the present disclosure;

FIG. 5 is still another schematic structural diagram of a terminal provided in one embodiment of the present disclosure.

### DETAILED DESCRIPTION

The following clearly and completely describes the technical solutions in the embodiments of the present disclosure with reference to the accompanying drawings in the embodiments of the present disclosure. Obviously, the described embodiments are a part rather than all of the embodiments of the present disclosure. All other embodiments acquired by persons of ordinary skill in the art based on the embodiments of the present disclosure without creative effort shall fall within the protective scope of the present disclosure.

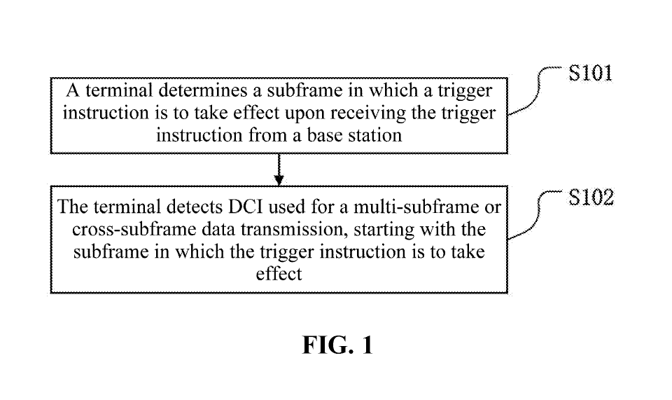

FIG. 1 is a flow chart of a method for detecting scheduling instructions in one embodiment of the present disclosure. In the embodiment of the present disclosure, the method includes:

S101, a terminal determines a subframe in which a trigger instruction is to take effect upon receiving the trigger instruction from a base station;

Specifically, the trigger instruction may be in a form of signaling or an indicator. Trigger signaling may be included in high layer signaling or physical layer signaling. Trigger signaling is customized signaling, and a trigger indicator is a customized string. The high layer signaling can be Radio Resource Control (RRC) signaling or a Media Access Control (MAC) Control Element (CE). The terminal receives the trigger instruction sent by the base station, and determines a subframe that triggers a multi-subframe or cross-subframe operation to take effect.

S102, the terminal detects Downlink Control Information (DCI) used for a multi-subframe or cross-subframe data transmission, starting with a subframe in which a multi-subframe or cross-subframe operation is to be triggered to take effect.

Specifically, the terminal detects the DCI used for the multi-subframe or cross-subframe data transmission, starting with the subframe, in which the trigger instruction is located. For example, the terminal detects DCI used for a non-multi-subframe or non-cross-subframe data transmission in subframe 1 and subframe 2, receives RRC signaling, a MAC CE or physical layer signaling including the trigger instruction from the base station, and determines a multi-subframe or cross-subframe operation is triggered in subframe 3. The terminal detects the DCI used for the multi-subframe or cross-subframe data transmission starting from subframe 3, and detects the DCI used for the multi-subframe or cross-subframe data transmission in each subframe after subframe 3, until the base station sends a release instruction. Of course, the terminal may also need to detect the DCI used for the non-multi-subframe or non-cross-subframe data transmission in subframe 3 and subsequent subframes.

In one possible embodiment of the present disclosure, in order to reduce a signaling interaction between the base station and the terminal, the terminal may do not need any instruction from the base station, and the method for detecting scheduling instructions may be that the terminal detects the DCI in each subframe, and if the DCI used for the multi-subframe data transmission or cross-subframe data transmission is found in a certain subframe, demodulates the DCI in the subframe, and performs a multi-subframe or cross-subframe data transmission operation according to an instruction of subframe scheduling information in the DCI.

In one possible embodiment of the present disclosure, the terminal detects the DCI used for the multi-subframe or cross-subframe data transmission in a subframe notified by the base station.

Specifically, the DCI is used for the multi-subframe or cross-subframe data transmission. A multi-subframe data transmission denotes that a scheduling instruction schedules a plurality of subframes for a data transmission. For example, a scheduling instruction in subframe n may schedule subframe n, subframe n+1, and subframe n+2 for the data transmission. The cross-subframe data transmission denotes that a scheduling instruction in a current subframe can be used to schedule other subframes for the data transmission. For example, a scheduling instruction in subframe n can schedule subframe n+3 for the data transmission. The terminal may detect the DCI in a manner notified by the base station. The notified manner may be that on an unlicensed frequency spectrum or a licensed frequency spectrum and through RRC signaling, a MAC CE or physical layer signaling, the base station notifies of a subframe number of the subframe, in which the DCI used for the multi-subframe or cross-subframe data transmission is located, and the base station detects the DCI used for the cross-subframe data transmission or the multi-subframe data transmission in the subframe corresponding to the subframe number.

It can be seen from the above embodiment that the terminal detects the DCI used for the multi-subframe or cross-subframe data transmission in each downlink subframe, or a downlink subframe notified by the base station, or a subframe in which the trigger instruction of the base station is located. Therefore, the terminal can accurately determine and detect scheduling instructions, so as to implement multi-subframe or cross-subframe scheduling.

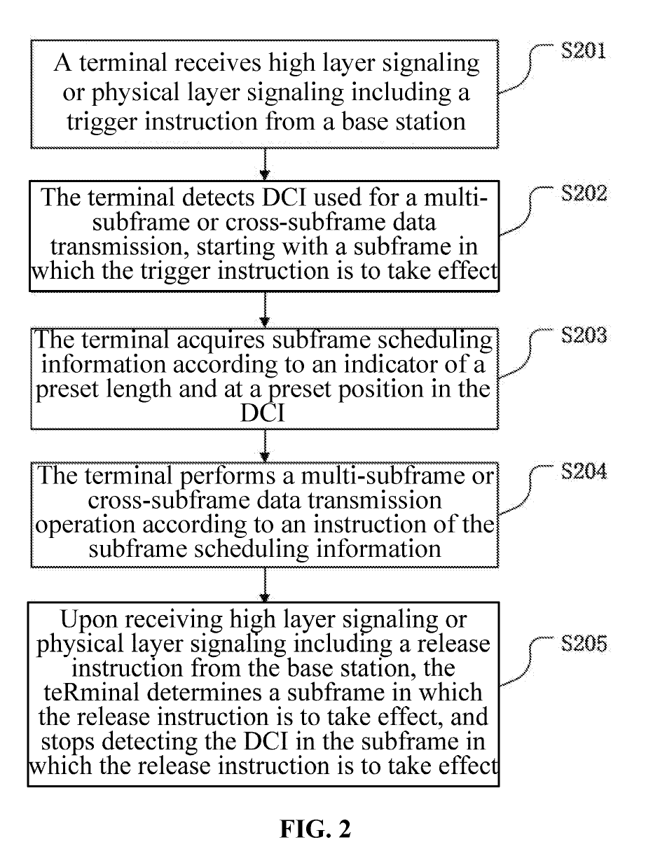

FIG. 2 is another flow chart of a method for detecting scheduling instructions in one embodiment of the present disclosure. In the embodiment of the present disclosure, the method includes:

S201, a terminal receives high layer signaling or physical layer signaling including a trigger instruction from a base station.

Specifically, the trigger instruction may include trigger signaling or a trigger indicator. The trigger signaling is customized signaling, and the trigger indicator is a customized string. The high layer signaling can be RRC signaling or a MAC CE. After the base station instructs the terminal to begin detecting DCI used for a multi-subframe or cross-subframe data transmission, the terminal is able to begin detecting the DCI used for the multi-subframe or cross-subframe data transmission. The manner in which the base station instructs the terminal to detect the DCI may be that the base station sends to the terminal the high layer signaling or the physical layer signaling including the trigger instruction, and the terminal detects the DCI used for the multi-subframe or cross-subframe data transmission, starting with a subframe in which a trigger operation is to be located. The high layer signaling or the physical layer signaling can be signaling used for transmitting public information or user-specific information. S202, the terminal detects DCI used for a multi-subframe or cross-subframe data transmission, starting with a subframe in which a multi-subframe or cross-subframe operation is to be triggered to take effect.

Specifically, the terminal detects the DCI used for the multi-subframe or cross-subframe data transmission, starting with the subframe in which the multi-subframe or cross-subframe operation is to be triggered to take effect. For example, the terminal detects DCI used for a non-multi-subframe or non-cross-subframe data transmission in subframe 1 and subframe 2, receives RRC signaling, a MAC CE or physical layer signaling including the trigger instruction from the base station, and determines that a multi-subframe or cross-subframe operation is to be triggered in subframe 3. The terminal detects the DCI used for the multi-subframe or cross-subframe data transmission starting from subframe 3, and detects the DCI used for the multi-subframe or cross-subframe data transmission in each subframe after subframe 3, until the base station sends a release instruction.

S203, the terminal acquires subframe scheduling information according to an indicator of a preset length and at a preset position in the DCI.

Specifically, the preset position identifies a position of a field in the DCI. The position may be an existing field or a customized field. The preset length represents a bit width of a binary number. The DCI consists of a field with a certain length. The base station configures the subframe scheduling information in the DCI. The subframe scheduling information is used to indicate position information of subframes for cross-subframe data transmission or multi-subframe data transmission. The base station sets different indicators of the preset length and at the preset position in the DCI to denote different subframe scheduling information. After detecting the DCI used for the multi-subframe or cross-subframe data transmission, the terminal acquires the indicator of the preset length and at the preset position in the DCI, and determines the subframe scheduling information according to a value of the indicator.

For example, an indicator of 3 high bits in the DCI can be the subframe scheduling information. 000 indicates scheduled subframes of subframe 1, 001 indicates scheduled subframes of subframe 1 and subframe 2, and 010 indicates scheduled subframes of subframe 1, subframe 2, and subframe 3. Representations as to subframe scheduling information in the DCI are not limited to these. Different values can be used to represent positions of different scheduled subframes according to requirements.

S204, the terminal performs a multi-subframe or cross-subframe data transmission operation according to an instruction of the subframe scheduling information.

Specifically, the terminal further needs to receive configuration information sent by the base station. The configuration information may include position information of the scheduled subframes, quantity information of the scheduled subframes, scheduling type information, and transmission format information. The terminal performs a multi-subframe or cross-subframe data transmission operation according to parameters included in the subframe scheduling information and the configuration information.

The scheduled subframes represent subframes used for the multi-subframe or cross-subframe data transmission. The position information of the scheduled subframes is used to indicate positions of one or more scheduled subframes used for the multi-subframe or cross-subframe data transmission. The position information is included in the configuration information, and the position information can be directly represented as a position of each scheduled subframe (such as a subframe number). The terminal may directly acquire specific positions of the scheduled subframes according to the position information. The position information may also be a rule as to distribution of positions of the scheduled subframes. The terminal may acquire specific positions of the scheduled subframes based on the distribution rule. For example, the base station notifies the terminal of a subframe interval of the scheduled subframes, and the terminal acquires the scheduled subframes according to the subframe interval.

It should be noted that the position information of the scheduled subframes can be included in the subframe scheduling information. The position information may be information which directly indicate positions, and the terminal acquires the scheduled subframes according to the position information included in the subframe scheduling information. Or the subframe scheduling information may include a scrambling sequence, and after receiving the subframe scheduling information, the terminal may detect the scrambling sequence to obtain specific positions of the scheduled subframes according to a predefined rule.

The quantity information of the scheduled subframes indicates a number of the scheduled subframes used for the multi-subframe or cross-subframe data transmission. The scheduling type information indicates a direction of scheduling, which includes uplink scheduling and downlink scheduling. The transmission format information indicates a data transmission format for the scheduled subframes. The data transmission format includes a level of modulation and coding scheme (MCS). In multi-subframe scheduling or cross-subframe scheduling, the data transmission format in each scheduled subframe may be same or different. If the data transmission format in the respective scheduled subframes is different, the base station may specify a transmission format of each subframe in the configuration information to better match channel conditions.

S205, upon receiving high layer signaling or physical layer signaling including a release instruction from the base station, the terminal determines a subframe in which the release instruction is located, and detects the DCI in the subframes in which the trigger instruction is to take effect.

Specifically, the base station sends the high layer signaling or the physical layer signaling including the release instruction to the terminal. The release instruction may be release signaling or a release indicator. The terminal stops detecting the DCI used for the multi-subframe or cross-subframe data transmission in the subframe in which the release instruction is located.

In one embodiment of the present disclosure, a method for detecting scheduling instructions may include:

a terminal receiving configuration information including subframe position information from a base station;

the terminal detecting DCI used for a multi-subframe or cross-subframe data transmission in a subframe corresponding to the subframe position information;

the terminal acquiring subframe scheduling information according to an indicator of preset length and at a preset position in the DCI;

the terminal performing a multi-subframe or cross-subframe data transmission operation according to an instruction of the subframe scheduling information.

Specifically, the base station sends the subframe position information to the terminal. The subframe position information is used to indicate a subframe number of a downlink subframe in which the DCI supporting multi-subframe or cross-subframe data transmission is located. The terminal can detect the DCI in the downlink subframe notified by the base station. A multi-subframe data transmission denotes that a scheduling instruction schedules multiple subframes for data transmission. For example, a scheduling instruction in subframe n may schedule subframe n, subframe n+1, and subframe n+2 for data transmission. The cross-subframe data transmission denotes that a scheduling instruction in a current subframe can be used to schedule other subframes for data transmission. For example, a scheduling instruction in subframe n can schedule subframe n+3 for data transmission. The terminal can detect the DCI in a manner notified by the base station. The notified manner may be that on an unlicensed frequency spectrum or a licensed frequency spectrum and through RRC signaling, a MAC CE or physical layer signaling, the base station notifies of a subframe number of the subframe in which the DCI is located, and the base station detects the DCI used for cross-subframe data transmission or multi-subframe data transmission in the subframe corresponding to the subframe number.

In one possible embodiment of the present disclosure, a method for detecting scheduling instructions may include:

a terminal detecting DCI used for a multi-subframe or cross-subframe data transmission in each subframe;

the terminal acquiring subframe scheduling information according to an indicator of preset length and at a preset position in the DCI;

the terminal performing a multi-subframe or cross-subframe data transmission operation according to an instruction of the subframe scheduling information.

Optionally, in the case that the scheduling type information indicates an uplink transmission, the scheduling instruction may further include starting position information (i.e., information as to starting position) of the uplink transmission.

Specifically, if the scheduling type information indicates an uplink transmission, the scheduling instruction may further include starting position information of the uplink transmission. For example, the terminal demodulates a scheduling instruction used for the multi-subframe or cross-subframe data transmission in subframe n, determines that the scheduling type information is uplink transmission according to the configuration information, and acquires starting position information of subframe n+4 of the uplink transmission from the configuration information. Starting with subframe n+4, the terminal performs uplink transmission according to the position information, the data information, and the transmission format of the scheduled subframes in the configuration information.

It can be seen from the above embodiment that the terminal detects the DCI used for the multi-subframe or cross-subframe data transmission in each downlink subframe, or a downlink subframe notified by the base station, or a subframe in which the trigger instruction of the base station is located. Therefore, the terminal can accurately determine and detect scheduling instructions, so as to implement multi-subframe or cross-subframe scheduling.

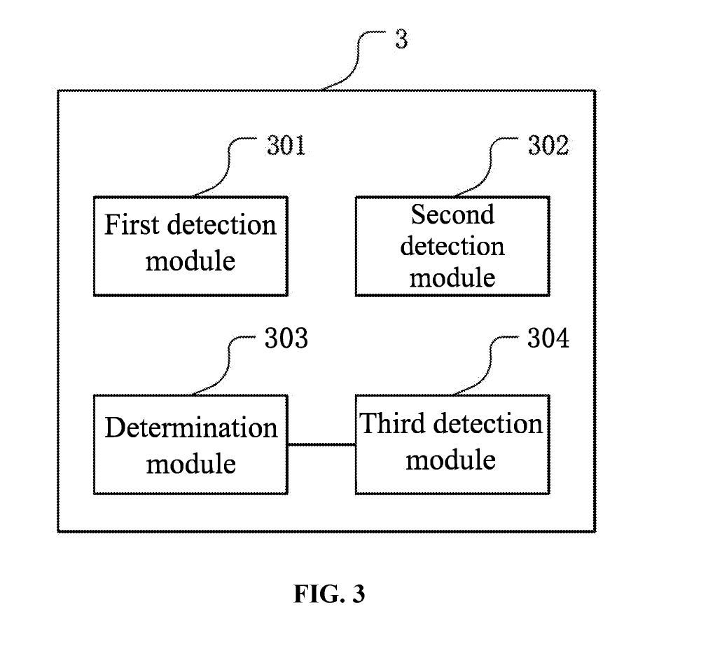

FIG. 3 is a schematic structural diagram of a terminal provided in one embodiment of the present disclosure. The terminal in the embodiment of the present disclosure executes the data transmission method of FIG. 1. The terms and processes involved may refer to the embodiment of FIG. 1. The terminal 3 may include a first detection module 301, or a second detection module 302, or a determination module 303 and a third detection module 304.

The first detection module 301 is configured to detect downlink control information (DCI) used for a multi-subframe or cross-subframe data transmission in each subframe; or

the second detection module 302 is configured to detect the DCI used for the multi-subframe or cross-subframe data transmission in a subframe notified by a base station; or

the determination module 303 is configured to determine a subframe in which a trigger instruction is to take effect upon receiving the trigger instruction from the base station; and

the third detection module 304 is configured to detect the DCI used for the multi-subframe or cross-subframe data transmission, starting with a subframe in which the trigger instruction is located.

The embodiment of the present disclosure and the method embodiment of FIG. 1 are based on the same concept, and the technical effects thereof are also the same. The processes in detail can refer to the description of the method embodiment 1, and are not repeated here.

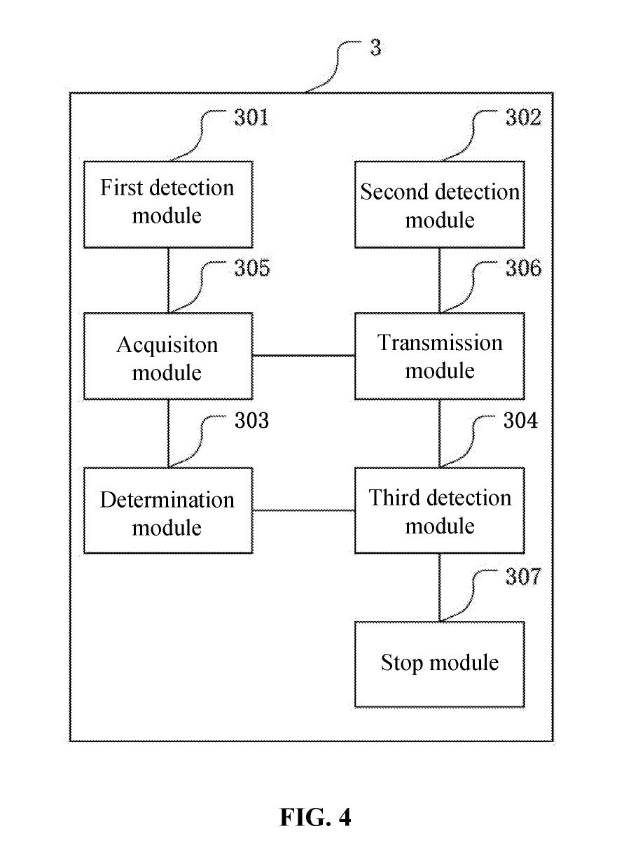

FIG. 4 is another schematic structural diagram of a terminal provided in one embodiment of the present disclosure. The terminal in the embodiment of the present disclosure is used to execute the data transmission method of FIG. 2. The terms and processes involved may refer to the embodiment of FIG. 2. The terminal 3 may further include an acquisition module 305, a transmission module 306, and a stop module 307.

The acquisition module 305 is configured to acquire subframe scheduling information according to an indicator of preset length and at a preset position in the DCI.

The transmission module 306 is configured to perform a multi-subframe or cross-subframe data transmission operation according to an instruction of the subframe scheduling information.

Optionally, the determination module 303 may be configured to:

upon receiving high layer signaling or physical layer signaling including a trigger instruction from the base station, determining a subframe in which a trigger instruction is to take effect.

Optionally, the terminal 3 may further include:

the stop module configured to upon receiving high layer signaling or physical layer signaling including a release instruction from the base station, determining a subframe in which the release instruction is located, and detecting the DCI in a subframe in which the trigger instruction is to take effect.

Optionally, the second detection module 302 may be configured to:

receive configuration information including subframe position information from the base station;

detect the DCI used for the multi-subframe or cross-subframe data transmission in a subframe corresponding to the subframe position information.

The embodiment of the present disclosure and the method embodiment 2 are based on the same concept, and the technical effects thereof are also the same. The processes in detail can refer to the description of the method embodiment 2, and are not repeated here.

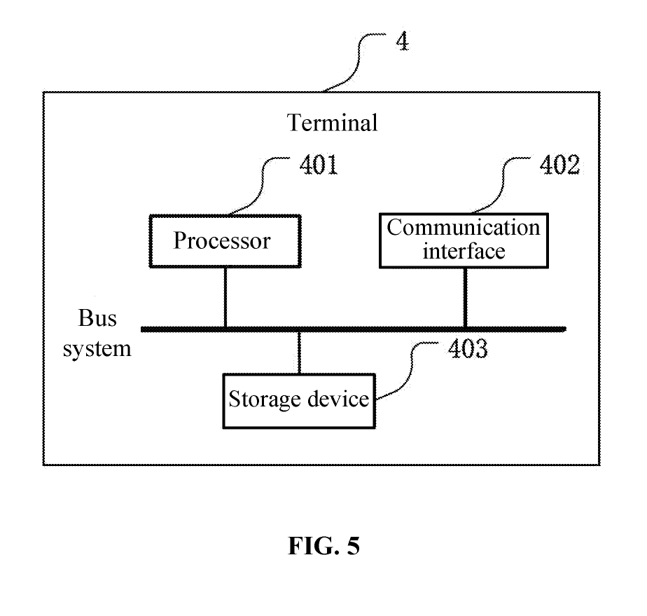

FIG. 5 is still another schematic structural diagram of a terminal provided in one embodiment of the present disclosure. In the embodiment of the present disclosure, the terminal 4 may include a processor 401, a storage device 403, and a communication interface 402. The communication interface 402 is used for sending and receiving data to and from external devices. The number of processors 401 in the terminal 4 can be one or more. In some embodiments of the present disclosure, the processor 401, the storage device 403, and the communication interface 402 may be connected through a bus system or other means. The terminal 4 can be used to execute the method shown in FIG. 1. The meaning and examples of the terms involved in this embodiment may refer to the embodiment of FIG. 1, and details are not repeated here.

The storage device 403 stores program codes. The processor 401 is used to invoke the program codes stored in the storage device 403 to execute the following operations:

detecting DCI used for a multi-subframe or cross-subframe data transmission in each subframe; or

detecting the DCI used for the multi-subframe or cross-subframe data transmission in a subframe as notified by a base station; or

determining a subframe in which a trigger instruction is to take effect upon receiving the trigger instruction from the base station; and

detecting the DCI used for the multi-subframe or cross-subframe data transmission, starting with a subframe in which a multi-subframe or cross-subframe operation is to be triggered to take effect.

In some embodiment of the present disclosure, the processor 401 is further used to execute operations of:

acquiring subframe scheduling information according to an indicator of a preset length and at a preset position in the DCI; and

performing a multi-subframe or cross-subframe data transmission operation according to an instruction of the subframe scheduling information.

In some embodiments of the present disclosure, the determining a subframe in which a trigger instruction is to take effect upon receiving the trigger instruction from a base station includes:

determining the subframe in which the trigger instruction is to take effect upon receiving high layer signaling or physical layer signaling including the trigger instruction from the base station.

In some embodiments of the present disclosure, after executing the operation of detecting the DCI used for the multi-subframe or cross-subframe data transmission, starting with a subframe in which a multi-subframe or cross-subframe operation is to be triggered to take effect, the processor 401 further executes an operation of:

upon receiving high layer signaling or physical layer signaling including a release instruction from the base station, determining a subframe in which the release instruction is located, and detecting the DCI in the subframe in which the trigger instruction is to take effect.

In some embodiments of the present disclosure, the detecting the DCI used for the multi-subframe or cross-subframe data transmission in a subframe notified by a base station includes:

receiving configuration information including subframe position information from the base station; and

detecting the DCI used for the multi-subframe or cross-subframe data transmission in a subframe corresponding to the subframe position information.

The terminal provided by the embodiments of the present disclosure includes, but is not limited to, a terminal equipped with iOS®, Android®, Microsoft® or other operating system, such as those in a mobile phone. Other terminals may also be used, such as a laptop or a tablet or a desktop computer with a touch-sensitive surface (e.g., a touch screen display and/or a touch pad).

A terminal including a display and a touch-sensitive surface is hereinafter described. It should be understood, however, that the terminal can include one or more other physical user interface devices, such as a physical keyboard, a mouse, and/or a joystick.

A terminal generally supports a variety of applications, such as one or more of a drawing application, a rendering application, a word processing application, a web page creation application, a disc editing application, a spreadsheet application, a game application, a phone application, a video conferencing application, an email application, an instant messaging application, a workout support application, a photo management application, a digital camera application, a digital video camera application, a web browsing application, a digital music player application, and/or a digital video player application.

Applications that can be executed on the terminal can use at least one shared physical user interface device, such as a touch-sensitive surface. One or more functions of the touch-sensitive surface and corresponding information displayed on the terminal may be adjusted and/or changed from one application to a next application, and/or adjusted and/or varied within applications. In this way, the shared physical architecture of the terminal, such as a touch-sensitive surface, can support applications with a user interface that is intuitive to the user.

Persons of ordinary skill in the art can understand that all or part of the processes of the above embodiments may be implemented by executing a computer program by related hardware. The program may be stored in a computer readable storage medium. The program, when executed, may implement the flow of the method embodiments as described above. The storage medium may be a magnetic disk, an optical disk, a read-only memory (ROM), or a random access memory (RAM).

What is claimed is:

1. A method for detecting scheduling instructions, comprising:
a terminal detecting Downlink Control Information (DCI) used for a multi-subframe or cross-subframe data transmission in each subframe; or
the terminal detecting the DCI used for the multi-subframe or cross-subframe data transmission in a subframe notified by a base station; or
the terminal determining a subframe in which a trigger instruction is to take effect upon receiving the trigger instruction from the base station; and
the terminal detecting the DCI used for the multi-subframe or cross-subframe data transmission, starting with the subframe in which the trigger instruction is to take effect.

2. The method according to claim 1, further comprising:
the terminal acquiring subframe scheduling information according to an indicator of a preset length and at a preset position in the DCI; and
the terminal performing a multi-subframe or cross-subframe data transmission operation according to an instruction of the subframe scheduling information.

3. The method according to claim 1, wherein the determining a subframe in which a trigger instruction is to take effect upon receiving the trigger instruction from the base station comprises:
the terminal determining the subframe in which the trigger instruction is to take effect upon receiving high layer signaling or physical layer signaling comprising the trigger instruction from the base station.

4. The method according to claim 1, wherein after the detecting the DCI used for the multi-subframe or cross-subframe data transmission, starting with the subframe in which the trigger instruction is to take effect, the method further comprises:
upon receiving high layer signaling or physical layer signaling comprising a release instruction from the base station, the terminal determining a subframe in which the release instruction is to take effect is to take effect, and stopping the detecting the DCI used for the multi-subframe or cross-subframe data transmission in the subframe in which the release instruction is to take effect.

5. The method according to claim 1, wherein the detecting the DCI used for the multi-subframe or cross-subframe data transmission in a subframe notified by a base station comprises:
the terminal receiving configuration information comprising subframe position information from the base station; and
the terminal detecting the DCI used for the multi-subframe or cross-subframe data transmission in a subframe corresponding to the subframe position information.

6. A terminal, comprising:
a processor; and
a storage device storing instructions that, when executed by the processor, cause the processor to perform operations of:
detecting Downlink Control Information (DCI) used for a multi-subframe or cross-subframe data transmission in each subframe; or
detecting the DCI used for the multi-subframe or cross-subframe data transmission in a subframe notified by a base station; or
determining a subframe in which a trigger instruction is to take effect upon receiving the trigger instruction from the base station;
detecting the DCI used for the multi-subframe or cross-subframe data transmission, starting with the subframe in which the trigger instruction is to take effect.

7. The terminal according to claim 6, wherein the instructions further cause the processor to perform operations of:
acquiring subframe scheduling information according to an indicator of a preset length and at a preset position in the DCI; and
performing a multi-subframe or cross-subframe data transmission operation according to an instruction of the subframe scheduling information.

8. The terminal according to claim 6, wherein the determining a subframe in which a trigger instruction is to take effect upon receiving the trigger instruction from the base station comprises:
determining the subframe in which the trigger instruction is to take effect upon receiving high layer signaling or physical layer signaling comprising the trigger instruction from the base station.

9. The terminal according to claim 6, wherein the instructions further cause the processor to perform an operation of:
upon receiving high layer signaling or physical layer signaling comprising a release instruction from the base station, determining a subframe in which the release instruction is to take effect, and stopping the detecting the DCI used for the multi-subframe or cross-subframe data transmission in the subframe in which the release instruction is to take effect.

10. The terminal according to claim 6, wherein the detecting the DCI used for the multi-subframe or cross-subframe data transmission in a subframe notified by a base station comprises:
receiving configuration information comprising subframe position information from the base station; and
detecting the DCI used for the multi-subframe or cross-subframe data transmission in a subframe corresponding to the subframe position information.

11. A non-transitory storage medium having stored thereon instructions that, when executed by a processor of a terminal, cause the processor to perform operations of:
detecting Downlink Control Information (DCI) used for a multi-subframe or cross-subframe data transmission in each subframe; or
detecting the DCI used for the multi-subframe or cross-subframe data transmission in a subframe notified by a base station; or
determining a subframe in which a trigger instruction is to take effect upon receiving the trigger instruction from the base station; and
detecting the DCI used for the multi-subframe or cross-subframe data transmission, starting with the subframe in which-the trigger instruction is to take effect.

12. The non-transitory storage medium of claim 11, wherein the instructions further cause the processor to perform operations of:
acquiring subframe scheduling information according to an indicator of a preset length and at a preset position in the DCI; and
performing a multi-subframe or cross-subframe data transmission operation according to an instruction of the subframe scheduling information.

13. The non-transitory storage medium of claim 11, wherein the determining a subframe in which a trigger instruction is to take effect upon receiving the trigger instruction from the base station comprises:
determining the subframe in which the trigger instruction is to take effect upon receiving high layer signaling or physical layer signaling comprising the trigger instruction from the base station.

14. The non-transitory storage medium of claim 11, wherein the instructions further cause the processor to perform an operation of:
upon receiving high layer signaling or physical layer signaling comprising a release instruction from the base station, determining a subframe in which the release instruction is to take effect, and stopping the detecting the DCI used for the multi-subframe or cross-subframe data transmission in the subframe in which the release instruction is to take effect.

15. The non-transitory storage medium of claim 11, wherein the detecting the DCI used for the multi-subframe or cross-subframe data transmission in a subframe notified by a base station comprises:
receiving configuration information comprising subframe position information from the base station; and
detecting the DCI used for the multi-subframe or cross-subframe data transmission in a subframe corresponding to the subframe position information.
